(19) United States
(12) Patent Application Publication
(10) Pub. No.: US 2025/0162038 A1
(43) Pub. Date: May 22, 2025

(54) Method Of Manufacturing Three-Dimensionally Shaped Object

(71) Applicant: SEIKO EPSON CORPORATION, Tokyo (JP)

(72) Inventor: Satoshi YAMAZAKI, Matsumoto (JP)

(21) Appl. No.: 18/955,106

(22) Filed: Nov. 21, 2024

(30) Foreign Application Priority Data
Nov. 22, 2023 (JP) 2023-198220

(51) Int. Cl. B22F 10/85; B22F 10/14; B22F 10/40; B29C 64/393; B29C 64/40; B33Y 40/20; B33Y 50/02

(52) U.S. Cl. CPC B22F 10/85; B22F 10/40; B29C 64/393; B29C 64/40; B33Y 40/20; B33Y 50/02; B22F 10/14

(57) ABSTRACT

A method for manufacturing a three-dimensionally shaped object includes a first step of acquiring designation information that designates a filling rate of a shaped object, a second step of generating first shaping data containing information on a first discharge quantity and a first discharge path and instructing formation of the shaped object in a contour region, a third step of generating second shaping data based on the designation information, the second shaping data containing information on a second discharge quantity and a second discharge path and instructing formation of the shaped object in an inner region, a fourth step of generating third shaping data containing information on a third discharge quantity and a third discharge path and instructing formation of a support structure in the inner region, a fifth step of shaping a three-dimensionally shaped object, and a sixth step of separating the support structure from the shaped object, and the fourth step includes generating, in one of the layers, the third shaping data in such a way that the third discharge path is at least partially located in a gap between segments of the second discharge path.

The present application is based on, and claims priority from JP Application Serial Number 2023-198220, filed Nov. 22, 2023, the disclosure of which is hereby incorporated by reference herein in its entirety.

### BACKGROUND

### 1. Technical Field

The present disclosure relates to a method for manufacturing a three-dimensionally shaped object.

### 2. Related Art

For example, JP-A-2017-007127 discloses a support arrangement determining apparatus that calculates the center of gravity of a three-dimensional model of a target object to be shaped and determines a surface of the three-dimensional model at which supports that support the target object to be shaped are arranged by using the calculated position of the center of gravity.

JP-A-2017-007127 is an example of the related art.

When a low-filling-rate shaped object is shaped, gaps are present inside the shaped object, so that the position of the shaped object shifts due to gravity before a shaping material inside the shaped object cures, and the shaping accuracy of the shaped object therefore decreases in some cases. There is therefore a demand for a technology capable of accurately shaping even a low-filling-rate shaped object.

### SUMMARY

According to a first aspect the present disclosure, a method for manufacturing a three-dimensionally shaped object is provided. The method for manufacturing a three-dimensionally shaped object is a method for manufacturing a three-dimensionally shaped object including a shaped object and a support structure that supports the shaped object by discharging a shaping material and a support material from a discharger toward a stage to stack layers on each other, the method including: a first step of acquiring designation information that designates a filling rate of the shaped object; a second step of generating first shaping data containing information on a first discharge quantity that is a quantity of the shaping material discharged per unit time by the discharger and information on a first discharge path that is a path along which the shaping material is discharged, and instructing formation of the shaped object in a contour region that constitutes a contour of the shaped object, a third step of generating second shaping data based on the designation information, the second shaping data containing information on a second discharge quantity that is a quantity of the shaping material discharged per unit time by the discharger and information on a second discharge path that is a path along which the shaping material is discharged, and instructing formation of the shaped object in an inner region inside the contour region; a fourth step of generating third shaping data containing information on a third discharge quantity that is a quantity of the support material discharged per unit time by the discharger and information on a third discharge path that is a path along which the support material is discharged, and instructing formation of the support structure in the inner region; a fifth step of shaping the three-dimensionally shaped object in accordance with the first shaping data, the second shaping data, and the third shaping data; and a sixth step of separating the support structure from the shaped object, and the fourth step includes generating, in one of the layers, the third shaping data in such a way that the third discharge path is at least partially located in a gap between segments of the second discharge path.

### BRIEF DESCRIPTION OF THE DRAWINGS

FIG. 1 is a descriptive view showing a schematic configuration of a three-dimensionally shaping system in the present embodiment.

FIG. 2 is a descriptive view showing a schematic configuration of a shaper.

FIG. 3 is a perspective view showing a schematic configuration of a screw.

FIG. 4 is a schematic plan view of a barrel.

FIG. 5 is a descriptive view diagrammatically showing that a three-dimensionally shaping apparatus shapes a three-dimensionally shaped object.

FIG. 6 is a descriptive view showing a schematic configuration of an information processing apparatus.

FIG. 7 shows steps of a method for manufacturing a three-dimensionally shaped object.

FIG. 8 illustrates the path along which a plasticized material is discharged in one layer.

FIG. 9 illustrates the path along which the plasticized material is discharged in one layer in a second embodiment.

FIG. 10 illustrates the path along which the plasticized material is discharged in one layer in a third embodiment.

FIG. 11 illustrates the path along which the plasticized material is discharged in one layer in the third embodiment.

FIG. 12 shows a part of the three-dimensionally shaped object shaped in accordance with the method for manufacturing a three-dimensionally shaped object according to the third embodiment.

FIG. 13 shows steps of the method for manufacturing a three-dimensionally shaped object according to a fourth embodiment.

FIG. 14 shows an example of an infilling path pattern.

FIG. 15 illustrates the path along which the plasticized material is discharged in one layer in the fourth embodiment.

FIG. 16 illustrates an infilling path pattern.

FIG. 17 illustrates another infilling path pattern.

FIG. 18 illustrates the path along which the plasticized material is discharged in one layer in a fifth embodiment.

FIG. 19 illustrates another example of the path along which the plasticized material is discharged in one layer in the fifth embodiment.

### DESCRIPTION OF EMBODIMENTS

### A. First Embodiment

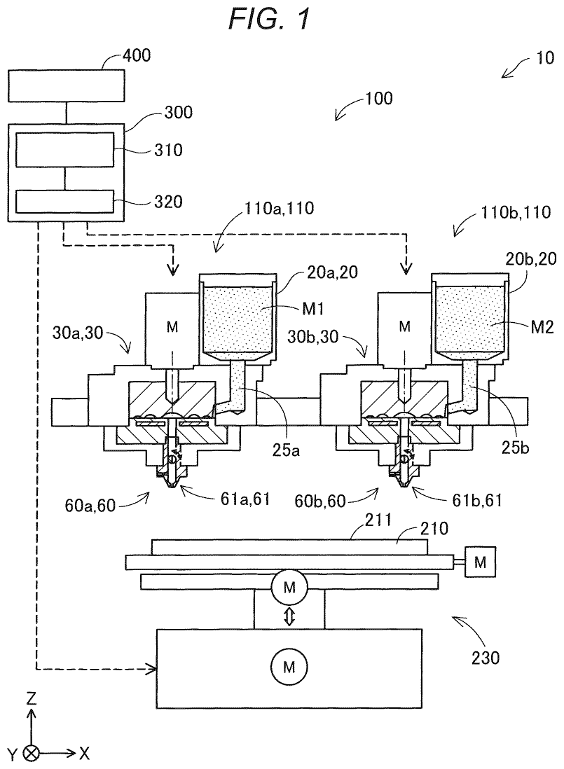

FIG. 1 is a descriptive view showing a schematic configuration of a three-dimensionally shaping system 10 in the present embodiment. FIG. 1 shows arrows indicating X, Y, and Z directions perpendicular to one another. The X direction and the Y direction are parallel to a horizontal plane. The Z direction is a direction parallel to the vertical direction. The X, Y, and Z directions in FIG. 1 and the X, Y, and Z directions in the other figures indicate the same directions. To specify an orientation, a positive or negative sign is added to the description of the direction, where “+” refers to a positive direction that is the direction indicated by an arrow, and “−” refers to a negative direction that is the opposite direction of the direction indicated by the arrow.

The three-dimensionally shaping system 10 includes a three-dimensionally shaping apparatus 100 and an information processing apparatus 400. The three-dimensionally shaping apparatus 100 in the present embodiment is an apparatus that uses a material extrusion method to shape a three-dimensionally shaped object including a shaped object and a support structure that supports the shaped object. The three-dimensionally shaping apparatus 100 includes a controller 300, which controls each section of the three-dimensionally shaping apparatus 100. The controller 300 and the information processing apparatus 400 are communicatively connected to each other.

The three-dimensionally shaping apparatus 100 includes a shaper 110, which produces and discharges a plasticized material, a shaping stage 210, which serves as a base for the three-dimensionally shaped object, and a moving mechanism 230, which controls the position where the plasticized material is discharged.

The shaper 110 discharges the plasticized material, which is a material as a result of plasticizing a solid-state material, onto the stage 210 under the control of the controller 300. The shaper 110 includes a material feeder 20, which is a source that feeds a raw material before being transformed into the plasticized material, a plasticizer 30, which transforms the raw material into the plasticized material, and a discharger 60, which discharges the plasticized material.

The three-dimensionally shaping apparatus 100 includes a first shaper 110a and a second shaper 110b as the shaper 110. The first shaper 110a includes a first material feeder 20a as the material feeder 20, a first plasticizer 30a as the plasticizer 30, and a first discharger 60a as the discharger 60. The second shaper 110b includes a second material feeder 20b as the material feeder 20, a second plasticizer 30b as the plasticizer 30, and a second discharger 60b as the discharger 60. The first shaper 110a and the second shaper 110b are arranged adjacent to each other in the X direction. The first shaper 110a and the second shaper 110b have the same configuration. To distinguish the constituent members of the two shapers from each other, the constituent members of the first shaper 110a each have a reference character “a”, and the constituent members of the second shaper 110b each have a reference character “b”. Note that the first shaper 110a and the second shaper 110b may be arranged adjacent to each other in the Y direction.

The first shaper 110a discharges a shaping material from the first discharger 60a toward the stage 210, and the second shaper 110b discharges a support material from the second discharger 60b toward the stage 210. The shaping material is a material used to form the shaped object, which is a product portion of the three-dimensionally shaped object, and the support material is a material used to form the support structure, which supports the shaped object during the shaping.

The first material feeder 20a feeds a raw material M1 of the shaping material to the first plasticizer 30a. The first material feeder 20a is configured, for example, with a hopper. The first material feeder 20a is coupled to the first plasticizer 30a through a communication path 25a. The raw material M1 of the shaping material is loaded into the first material feeder 20a in the form of pellets, powder, or the like. The raw material M1 of the shaping material is made of a material insoluble in water or a solvent. The raw material M1 of the shaping material can, for example, be a material that is the combination of ABS resin, polylactic acid (PLA), polyetherimide (PEI), or nylon 12 and carbon fibers.

The second material feeder 20b feeds a raw material M2 of the support material to the second plasticizer 30b. The second material feeder 20b is configured, for example, with a hopper. The second material feeder 20b is coupled to the second plasticizer 30b through a communication path 25b. The raw material M2 of the support material is loaded into the second material feeder 20b in the form of pellets, powder, or the like. The raw material M2 of the support material is made of a material soluble in water or a solvent. The raw material M2 of the support material can, for example, be high impact polystyrene (HIPS) or polyvinyl alcohol (PVA). When the raw material M1 of the shaping material and the raw material M2 of the support material are not particularly distinguished from each other in the following description, the two materials are simply referred to as the material. When the shaping material and the support material are not particularly distinguished from each other in the description, the two m materials are referred to as the plasticized material.

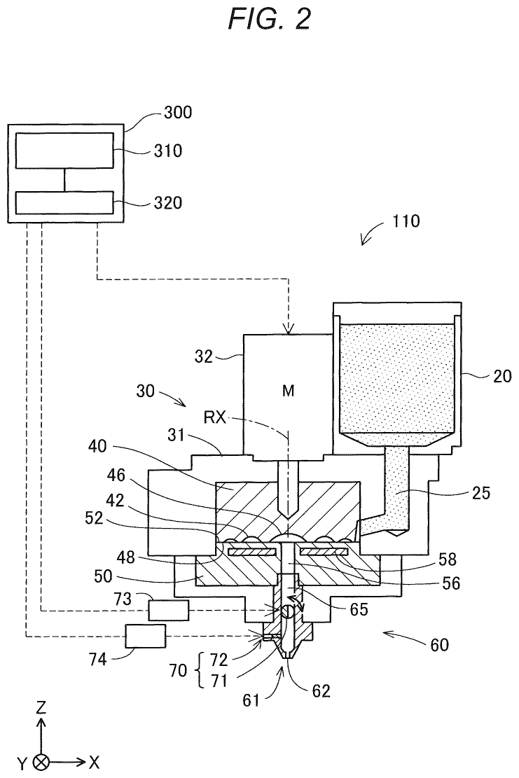

FIG. 2 is a descriptive view showing a schematic configuration of the shaper 110. The plasticizer 30 and the discharger 60 will be described below with reference to FIG. 2.

The plasticizer 30 plasticizes at least a part of the material fed from the material feeder 20, and guides the plasticized material to the discharger 60. The term “plasticizing” used herein is a concept including melting and means changing a solid state to a flowable state. Specifically, in the case of a material that experiences glass transition, plasticizing means raising the temperature of the material to the glass transition point or higher. In the case of a material that does not experience glass transition, plasticizing means raising the temperature of the material to the melting point or higher. The plasticizer 30 includes a screw case 31, a driving motor 32, a screw 40, and a barrel 50.

The screw 40 is housed in the screw case 31. An upper-surface-side portion of the screw 40 is linked to the driving motor 32. The screw 40 is rotated in the screw case 31 by the rotational driving force produced by the driving motor 32. The direction of an axis of rotation RX of the screw 40 is the direction along the Z direction. The rotational speed of the screw 40 is controlled by the controller 300 controlling the rotational speed of the driving motor 32. Note that the screw 40 may be driven by the driving motor 32 via a speed reducer. The screw 40 is also referred to as a rotor or a flat screw.

The barrel 50 is disposed at the side of the screw 40 that faces the negative end of the Z direction. A facing surface 52, which is the upper surface of the barrel 50, faces a lower surface 48 of the screw 40. A communication hole 56, which communicates with a channel 65 of the discharger 60, is formed at the center of the barrel 50. A heater 58 is provided inside the barrel 50. The temperature of the heater 58 is controlled by the controller 300.

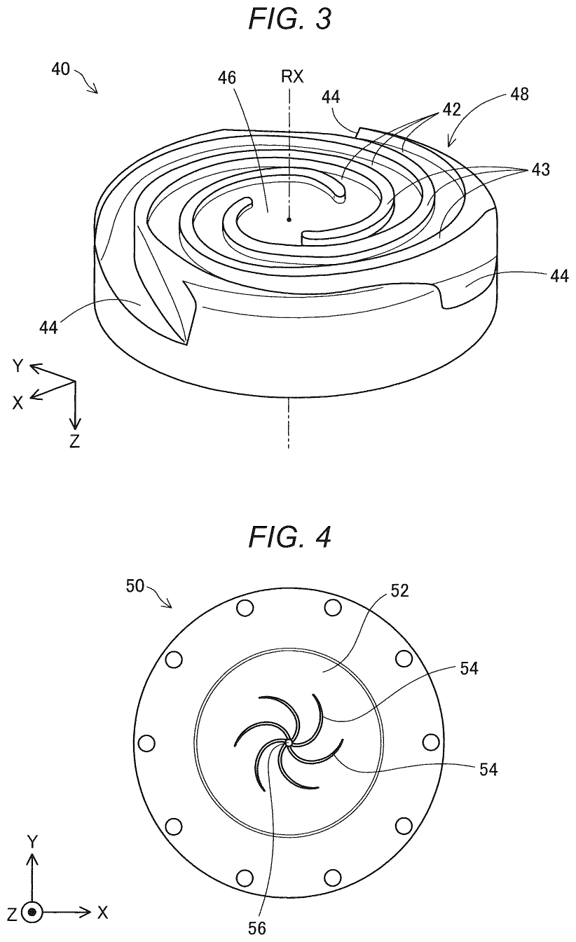

FIG. 3 is a perspective view showing a schematic configuration of the screw 40. The screw 40 has a substantially cylindrical shape having a length in the direction along the axis of rotation RX smaller than the length of the screw 40 in a direction perpendicular to the axis of rotation RX. Vortex grooves 42 are formed in the lower surface 48 of the screw 40 around a central section 46. The grooves 42 communicate with material loading ports 44 formed in the side surface of the screw 40. The material fed from the material feeder 20 is fed to the grooves 42 via the material loading ports 44. The grooves 42 are formed so as to be separated by protruding rows 43. FIG. 3 shows a case where three grooves 42 are formed, and the number of grooves 42 may be one or may be two or more. The grooves 42 do not necessarily have vortex shapes and may have spiral shapes or the shapes of involute curves, or may have shapes extending arcuately from the central section 46 toward the outer circumference.

FIG. 4 is a schematic plan view of the barrel 50. Multiple guide grooves 54 are formed in the facing surface 52 around the communication hole 56. The guide grooves 54 each have one end coupled to the communication hole 56 and extend in the form of vortex from the communication hole 56 toward the outer circumference of the facing surface 52. One end of each of the guide grooves 54 may not be coupled to the communication hole 56. The guide grooves 54 may not be formed in the barrel 50.

The material fed to the grooves 42 of the screw 40 flows along the grooves 42 while being plasticized in the grooves 42 by the rotation of the screw 40 and the heat from the heater 58 and is guided to the central section 46 of the screw 40. The plasticized material in the form of paste having flowed into the central section 46 and showing fluidity is fed to the discharger 60 through the communication hole 56. Note that not all kinds of substances that constitute the plasticized material may be plasticized in the plasticizer 30. The plasticized material only needs to be transformed into the state having fluidity as a whole by plasticizing at least a part of substances that constitute the plasticized material.

The discharger 60 discharges the material plasticized in the plasticizer 30. The discharger 60 includes a nozzle 61, the channel 65, and a discharge controller 70.

The nozzle 61 is coupled to the communication hole 56 of the barrel 50 through the channel 65. The nozzle 61 discharges the plasticized material via a nozzle opening 62 at the tip of the nozzle 61 toward the stage 210. The nozzle 61 of the first discharger 60a is hereinafter also referred to as a first nozzle 61a, and the nozzle 61 of the second discharger 60b is also referred to as a second nozzle 61b.

The discharge controller 70 includes a discharge adjuster 71, which opens and closes the channel 65, and a suction section 72, which suctions and temporarily stores the plasticized material.

The discharge adjuster 71 is provided in the channel 65 and rotates in the channel 65 to change the opening of the channel 65. In the present embodiment, the discharge adjuster 71 is configured with a butterfly valve. The discharge adjuster 71 is driven by a first driver 73 under the control of the controller 300. The first driver 73 is configured, for example, with a stepper motor. The controller 300 can adjust the flow rate of the plasticized material flowing from the plasticizer 30 to the nozzle 61, that is, the quantity of the discharged plasticized material discharged from the nozzle 61 by using the first driver 73 to control the angle of rotation of the butterfly valve. The discharge adjuster 71 can adjust the quantity of the discharged plasticized material and can also control whether the plasticized material is caused to flow out.

The suction section 72 is coupled to and between the discharge adjuster 71 and the nozzle opening 62 in the channel 65. The suction section 72 temporarily suctions the plasticized material in the channel 65 when the plasticized material discharged is not discharged from the nozzle 61 to suppress a tailing phenomenon in which the plasticized material drips down in the form of a string via the nozzle opening 62. In the present embodiment, the suction section 72 is configured with a plunger. The suction section 72 is driven by a second driver 74 under the control of the controller 300. The second driver 74 is configured, for example, with a stepper motor and a rack-and-pinion mechanism that converts the rotational force produced by the stepper motor into a translational motion of the plunger.

The stage 210 shown in FIG. 1 is disposed at a position where the stage 210 faces the nozzle opening 62 of the nozzle 61. The three-dimensionally shaping apparatus 100 shapes a three-dimensionally shaped object by discharging the plasticized material from the nozzle 61 onto a shaping surface 211, which is the upper surface of the stage 210, to stack layers on each other. The stage 210 may be provided with a heater that suppresses rapid cooling of the plasticized material discharged onto the stage 210.

The moving mechanism 230 changes the positional relationship between the nozzle 61 and the stage 210. In the present embodiment, the moving mechanism 230 moves the stage 210 with respect to the nozzle 61 fixed at a certain position. The change in the position of the nozzle 61 with respect to the stage 210 is also simply referred to as movement of the nozzle 61. The moving mechanism 230 is configured with a three-axis positioner that moves the stage 210 in three axial directions, X, Y, and Z directions, with driving forces produced by three motors. The motors of the moving mechanism 230 are driven under the control of the controller 300. Note that the moving mechanism 230 may not be configured to move the stage 210 and may instead be configured to move the nozzle 61 with the position of the stage 210 fixed. Still instead, the moving mechanism 230 may be configured to move both the stage 210 and the nozzle 61.

The controller 300 is a control apparatus that controls the overall operation of the three-dimensionally shaping apparatus 100. The controller 300 is configured with a computer including one or more processors 310, a storage 320, and an input/output interface that inputs and outputs signals from and to an external apparatus. The processor 310 executes a program stored in the storage 320 to control the three-dimensionally shaping apparatus 100 in accordance with shaping data acquired from the information processing apparatus 400 to shape a three-dimensionally shaped object on the stage 210. Note that the controller 300 may be achieved by a configuration that is a combination of circuits instead of being configured with a computer.

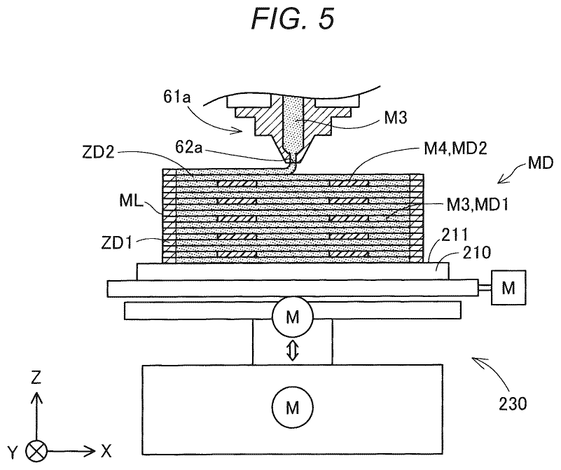

FIG. 5 is a descriptive view diagrammatically showing that the three-dimensionally shaping apparatus 100 shapes a three-dimensionally shaped object MD. In the three-dimensionally shaping apparatus 100, a shaping material M3 and a support material M4 are produced, as described above. The controller 300 causes the shaping material M3 to be discharged from the first nozzle 61a with the distance between the shaping surface 211 of the stage 210 and the first nozzle 61a maintained while changing the position of the first nozzle 61a with respect to the stage 210 in the direction along the shaping surface 211 of the stage 210. The controller 300 further causes the support material M4 to be discharged from the second nozzle 61b with the distance between the shaping surface 211 of the stage 210 and the second nozzle 61b (not shown) maintained while changing the position of the second nozzle 61b with respect to the stage 210 in the direction along the shaping surface 211 of the stage 210. The material discharged from the nozzle 61 is continuously deposited in the direction in which the nozzle 61 is moved.

The controller 300 forms layers ML by repeating the movement of the nozzle 61. One layer ML is made of only the shaping material M3 or both the shaping material M3 and the support material M4. After forming one layer ML, the controller 300 moves the position of the nozzle 61 with respect to the stage 210 in the Z direction. The controller 300 then shapes a shaped object MD1 and a support structure MD2 by further stacking another layer ML on the layer ML that has been formed. Hereinafter, the lowermost layer ML is referred to as a first layer, and the n-th (n is natural number) layer ML counted from the first layer is referred to as an n-th layer.

For example, when the operation of discharging the shaping material M3 from the first nozzle 61a and the operation of discharging the support material M4 from the second nozzle 61b are switched from one to the other during the formation of one layer ML, when the nozzle 61 is moved in the Z direction after the operation of shaping a layer ML corresponding to one layer is completed, or when each layer ML has multiple independent shaped regions, the controller 300 may temporarily interrupt the operation of discharging the plasticized material from the nozzle 61. In this case, the discharge controller 70 closes the channel 65 to stop discharging the plasticized material via the nozzle opening 62, and causes the suction section 72 to temporarily suction the plasticized material in the nozzle 61. After changing the position of the nozzle 61, the controller 300 causes the discharge controller 70 to open the channel 65 while discharging the plasticized material in the suction section 72, and restarts depositing the plasticized material at the changed position of the nozzle 61.

The shaped object MD1 has a contour region ZD1 and an inner region ZD2. The contour region ZD1 is a region that constitutes the contour of the shaped object MD1, and means a portion located at the contour of the shaped object MD1 having gone through the shaping operation. The inner region ZD2 is a region inside the contour region ZD1, and means a portion located inside the shaped object MD1 having gone through the shaping operation. The inner region ZD2 is also referred to as infilling. In FIG. 5, the contour region ZD1 is hatched with oblique lines to clearly show the contour region ZD1.

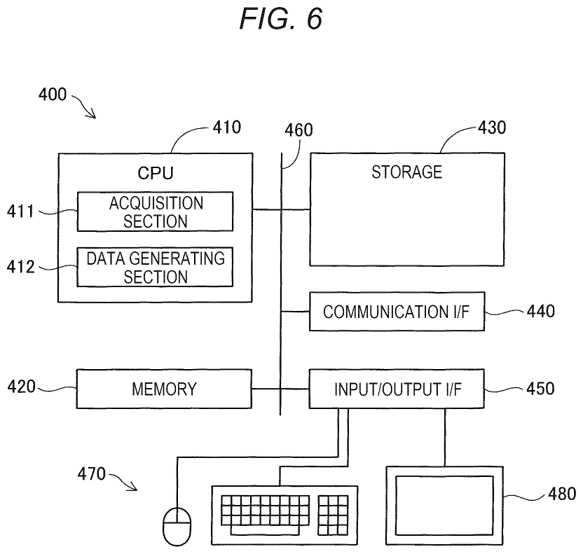

FIG. 6 is a descriptive view showing a schematic configuration of the information processing apparatus 400. The information processing apparatus 400 is configured as a computer including a CPU 410, a memory 420, a storage 430, a communication interface 440, and an input/output interface 450, which are coupled to each other via a bus 460. An input device 470 such as a keyboard and a mouse and a display device 480 such as a liquid crystal display are coupled to the input/output interface 450. The information processing apparatus 400 is coupled to the controller 300 of the three-dimensionally shaping apparatus 100 via the communication interface 440.

The CPU 410 functions as an acquisition section 411 and a data generating section 412 by executing a program stored in the storage 430.

The acquisition section 411 acquires designation information that designates the filling rate of the shaped object MD1.

The data generating section 412 generates shaping data that is data used to shape the three-dimensionally shaped object MD. The shaping data contains first shaping data, second shaping data, and third shaping data, which will be described later.

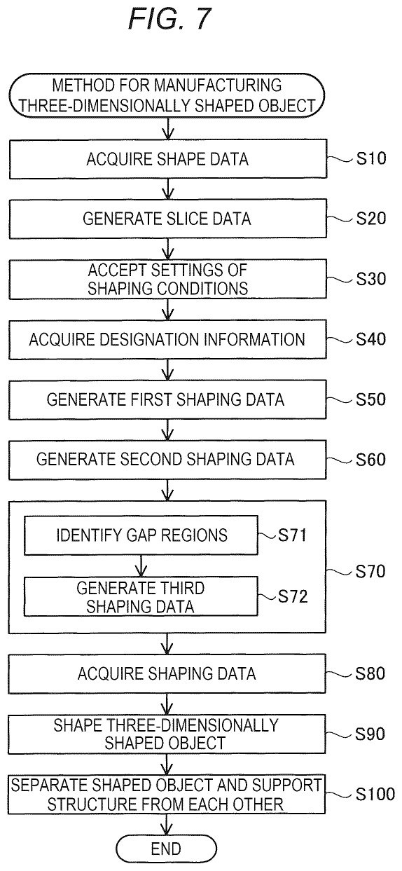

FIG. 7 shows steps of a method for manufacturing a three-dimensionally shaped object. The steps of steps S10 to S70 are executed in the information processing apparatus 400, and the steps of steps S80 and S90 are executed in the three-dimensionally shaping apparatus 100.

In step S10, the data generating section 412 of the information processing apparatus 400 acquires shape data representing the three-dimensional shape of the shaped object MD1 from another computer, a recording medium, or the storage 430. The shape data is data representing the shape of the three-dimensionally shaped object MD1 created by using three-dimensional CAD software, three-dimensional CG software, or the like. The shape data can, for example, be data in an STL format or an AMF format.

In step S20, the data generating section 412 generates slice data. The slice data refers to data representing the shape of the shaped object MD1 sliced into multiple layers. More specifically, the data generating section 412 generates the slice data by slicing the shape of the shaped object MD1 indicated by the shape data along the XY plane into multiple layers.

In step S30, the data generating section 412 accepts settings of shaping conditions relating to the three-dimensionally shaped object MD from a user. The user uses the input device 470 to operate a setting screen displayed on the display device 480 to set the shaping conditions. Examples of the shaping conditions include a linewidth, a shaping pattern, and a filling rate of a shaped object. The “linewidth” is the width of the plasticized material discharged from the nozzle 61. The “shaping pattern” is a pattern indicating the path along which the nozzle 61 is moved to fill the inner region ZD2 of each of the layers ML with the shaping or support material. The “filling rate of the shaped object” is an area proportion of the shaping material M3 that fills the inner region ZD2 in accordance with the designated shaping pattern. Assume now the user sets a value smaller than 100% as the filling rate of the shaped object. The shaping pattern is also hereinafter referred to as an infilling path pattern.

In step S40, the acquisition section 411 acquires the designation information. The acquisition section 411 acquires as the designation information the filling rate of the shaped object contained in the shaping conditions accepted by the data generating section 412 in step S30. Step S40 is also referred to as a first step.

In step S50, the data generating section 412 generates the first shaping data based on the slice data and the shaping conditions. The first shaping data is data instructing formation of the shaped object MD1 in the contour region ZD1. The first shaping data contains information on a first discharge quantity that is the quantity of the shaping material M3 discharged per unit time by the first discharger 60a, and information on a first discharge path that is the path along which the shaping material M3 is discharged. The path along which the shaping material M3 is discharged is the path along which the first nozzle 61a moves along and with respect to the shaping surface 211 of the stage 210. The first shaping data contains the information on the first discharge quantity and the information on the first discharge path for each of the multiple layers into which the shape of the shaped object MD1 has been sliced. The data generating section 412 preferably generates the first shaping data on a layer basis sequentially through the layers ML from top to bottom. Note that the data generating section 412 may generate the first shaping data on a layer basis sequentially through the layers ML from bottom to top.

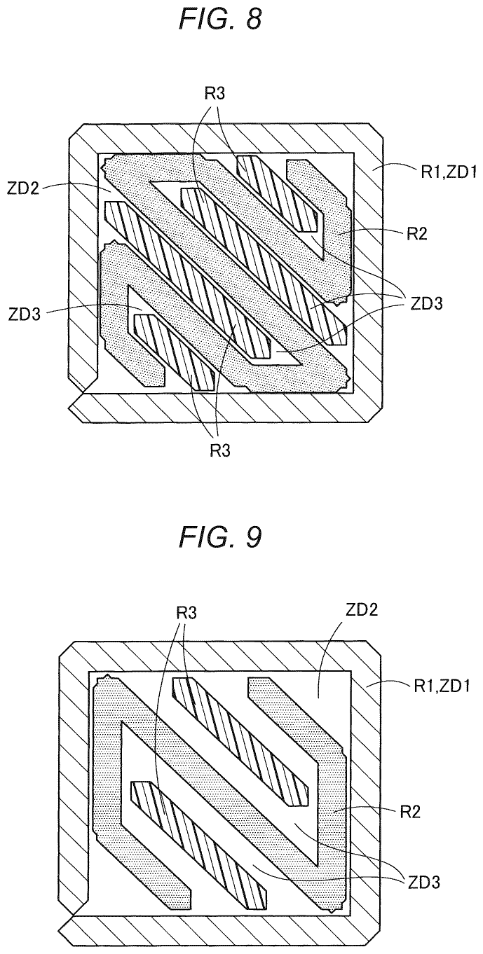

FIG. 8 illustrates the path along which the plasticized material is discharged in one layer ML. FIG. 8 shows a state in which one layer ML is viewed from above. In step S50, the data generating section 412 determines the first discharge quantity and a first discharge path R1 used to form the shaped object MD1 in the contour region ZD1 shown in FIG. 8. FIG. 8 shows, as the first discharge path R1, a path that makes one round along the contour of the shaped object MD1. The first discharge path R1 may be a path that makes two or more rounds along the contour of the shaped object MD1. Step S50 is also referred to as a second step.

In step S60 in FIG. 7, the data generating section 412 generates the second shaping data based on the slice data and the shaping conditions. The second shaping data is data instructing formation of the shaped object MD1 in the inner region ZD2. The second shaping data contains information on a second discharge quantity that is the quantity of the shaping material M3 discharged per unit time by the first discharger 60a, and information on a second discharge path that is the path along which the shaping material M3 is discharged. The second shaping data contains the information on the second discharge quantity and the information on the second discharge path for each of the multiple layers into which the shape of the shaped object MD1 has been sliced. The data generating section 412 generates the second shaping data on a layer basis sequentially through the layers ML from top to bottom. Note that the data generating section 412 may generate the second shaping data on a layer basis sequentially through the layers ML from bottom to top.

In step S60, the data generating section 412 determines the second discharge quantity and a second discharge path R2 used to form the shaped object MD1 in the inner region ZD2 shown in FIG. 8. At this point of time, the data generating section 412 determines the second discharge quantity and the second discharge path R2 based on the designation information acquired in step S40. Specifically, the data generating section 412 determines the second discharge quantity and the second discharge path R2 in such a way that the filling rate of the shaping material M3 in each of the layers ML is equal to the designation information. The filling rate of the shaping material M3 in each of the layers ML is an area proportion of the shaping material M3 in the inner region ZD2 in the top view of the layer ML. The data generating section 412 generates the second shaping data in such a way that the second discharge path R2 in the inner region ZD2 and the first discharge path R1 in the contour region ZD1 are at least partially in contact with each other. Furthermore, the data generating section 412 generates the second shaping data in such a way that holes that communicate with the inner region ZD2 are formed in the three-dimensionally shaped object MD when the shaping of the three-dimensionally shaped object MD is completed. Specifically, the data generating section 412 generates the second shaping data in such a way that gaps formed inside the shaped object MD1 communicate with the outer space of the shaped object MD1. Step S60 is also referred to as a third step.

In step S70 in FIG. 7, the data generating section 412 generates the third shaping data based on the slice data and the shaping conditions. The third shaping data is data instructing formation of the support structure MD2 in the inner region ZD2. The third shaping data contains information on a third discharge quantity that is the quantity of the support material M4 discharged per unit time by the second discharger 60b, and information on a third discharge path that is the path along which the support material M4 is discharged. The path along which the support material M4 is discharged is the path along which the second nozzle 61b moves along and with respect to the shaping surface 211 of the stage 210. The third shaping data contains the information on the third discharge quantity and the information on the third discharge path for each of the multiple layers into which the shape of the shaped object MD1 has been sliced. The data generating section 412 generates the third shaping data on a layer basis sequentially through the layers ML from top to bottom. Step S70 includes step S71 and step S72. Step S70 is also referred to as a fourth step. Note that the data generation section 412 may generate the third shaping data on a layer basis sequentially through the layers ML from bottom to top.

In step S71, the data generating section 412 identifies gap regions ZD3, which are regions where the shaping material M3 is not discharged in the inner region ZD2. The data generating section 412 identifies portions of the inner region ZD2 where the second discharge path R2 is not located as the gap regions ZD3.

The data generating section 412 generates the third shaping data in step S72. The data generating section 412 generates the third shaping data in such a way that the support material M4 is discharged to the gap regions ZD3 identified in step S71, as shown in FIG. 8. That is, the data generating section 412 determines the third discharge quantity and a third discharge path R3 in such a way that the third discharge path R3 is at least partially located in each gap between segments of the second discharge path R2. The data generating section 412 preferably generates the third shaping data in such a way that the sum of the filling rate of the shaping material M3 and the filling rate of the support material M4 in each of the layers ML is a value close to 100%.

In step S80, the controller 300 of the three-dimensionally shaping apparatus 100 acquires, from the information processing apparatus 400, the shaping data including the first shaping data, the second shaping data, and the third shaping data generated by the information processing apparatus 400 in steps S50 to S70.

In step S90, the controller 300 controls the first discharger 60a, the second discharger 60b, and the moving mechanism 230 in accordance with the shaping data acquired from the information processing apparatus 400, and shapes the shaped object MD1 and the support structure MD2 on the shaping surface 211 of the stage 210 to shape the three-dimensionally shaped object MD. Step S90 is also referred to as a fifth step.

In step S100, the user separates the support structure MD2 from the shaped object MD1. The user dissolves the support structure MD2 by immersing the three-dimensionally shaped object MD in a liquid that dissolves only the support structure MD2 of the three-dimensionally shaped object MD, such as water and a solvent. Step S100 is also referred to as a sixth step.

According to the first f embodiment described above, the data generating section 412 generates the third shaping data in such a way that the third discharge path R3 is at least partially located in each gap between segments of the second discharge path R2 in one layer ML. Therefore, when the three-dimensionally shaped object MD is shaped, the support structure MD2 is formed in each gap present inside the shaped object MD1. The thus formed support structure MD2 can suppress shift of the positions of the shaping material M3 discharged to regions above the support structure MD2 due to gravity before the shaping material M3 cures. Even a low-filling-rate shaped object MD1 can therefore be shaped with high accuracy.

In the present embodiment, the data generating section 412 identifies the gap regions ZD3 and generates the third shaping data in such a way that the support material M4 is discharged to the gap regions ZD3. The present embodiment can therefore suppress discharging the support material M4 to the region where the shaping material M3 has already been discharged in the shaping of the three-dimensionally shaped object MD.

In the present embodiment, the data generating section 412 generates the second shaping data in such a way that the second discharge path R2 in the inner region ZD2 and the first discharge path R1 in the contour region ZD1 are at least partially in contact with each other. Therefore, when the support structure MD2 is separated from the shaped object MD1, separation of the shaped object MD1 in the contour region ZD1 from the shaped object MD1 in the inner region ZD2 can be suppressed.

In the present embodiment, the data generating section 412 generates the second shaping data in such a way that the holes that communicate with the inner region ZD2 are formed in the three-dimensionally shaped object MD. Accordingly, when the three-dimensionally shaped object MD is immersed in the liquid that dissolves only the support structure MD2, the liquid described above flows into the interior of the three-dimensionally shaped object MD. The support structure MD2 can therefore be readily separated from the shaped object MD1.

### B. Second Embodiment

In a second embodiment, the process in step S72 of the method for manufacturing a three-dimensionally shaped object differs from that in the first embodiment. The processes other than that in step S72 and the configuration of the three-dimensionally shaping system 10 are the same as those in the first embodiment.

FIG. 9 illustrates the path along which the plasticized material is discharged in one layer ML in the second embodiment. FIG. 9 shows the state in which one layer ML is viewed from above. In the second embodiment, in step S72 in FIG. 7, the data generating section 412 generates the third shaping data in such a way that the support material M4 is discharged to some of the gap regions ZD3 identified in step S71. The data generating section 412 preferably determines the third discharge path R3 in such a way that the gap regions ZD3 are divided by the support material M4, as shown in FIG. 9. The data generating section 412 generates the third shaping data in such a way that the sum of the filling rate of the shaping material M3 and the filling rate of the support material M4 in each of the layers ML is a value smaller than 100%.

According to the second embodiment described above, the data generating section 412 generates the third shaping data in such a way that the third discharge path R3 is at least partially located in each gap between segments of the second discharge path R2 in one layer ML. Even a low-filling-rate shaped object MD1 can therefore be shaped with high accuracy, as in the first embodiment.

### C. Third Embodiment

In a third embodiment, the process in step S72 of the method for manufacturing a three-dimensionally shaped object differs from that in the first embodiment. The processes other than that in step S72 and the configuration of the three-dimensionally shaping system 10 are the same as those in the first embodiment.

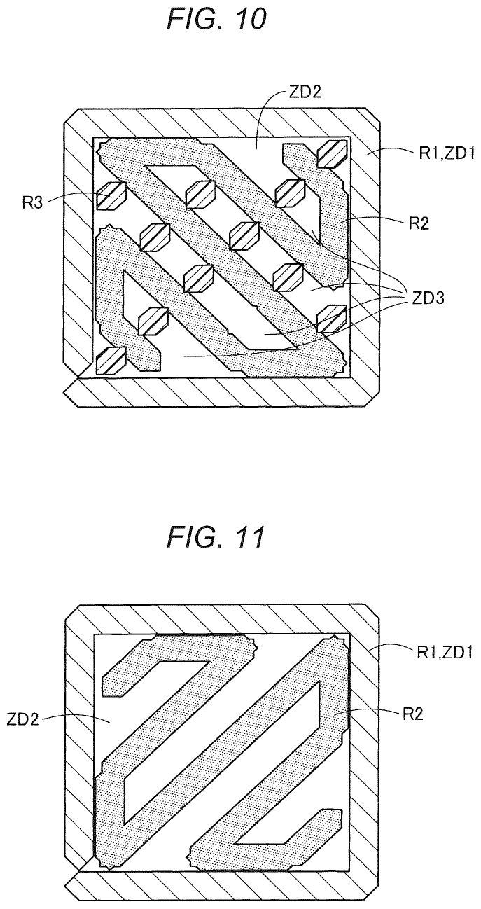

FIGS. 10 and 11 illustrate the path along which the plasticized material is discharged in one layer ML in the third embodiment. FIG. 10 shows a state in which the (n+1)-th layer is viewed from above. FIG. 11 shows a state in which the (n+2)-th layer is viewed from above.

The data generating section 412 generates the third shaping data on a layer basis sequentially through the layers ML from top to bottom. In the third embodiment, in step S72 in FIG. 7, the data generating section 412 generates the third shaping data on the (n+1)-th layer in such a way that the support material M4 is discharged to a region where the second discharge path R2 in the (n+2)-th layer and the gap regions ZD3 in the (n+1)-th layer overlap with each other in the vertical direction. In other words, the data generating section 412 determines the third discharge path R3 in the (n+1)-th layer in such a way that the support material M4 is discharged to a region where the region to which the shaping material M3 is discharged in the (n+2)-th layer and the gap regions ZD3 in the (n+1)-th layer overlap with each other in the vertical direction. When there is a region to which the support material M4 is discharged in the (n+2)-th layer, the data generating section 412 generates the third shaping data on the (n+1)-th layer in such a way that the support material M4 is discharged to a region where the second discharge path R2 or the third discharge path R3 in the (n+2)-th layer and the gap regions ZD3 in the (n+1)-th layer overlap with each other in the vertical direction.

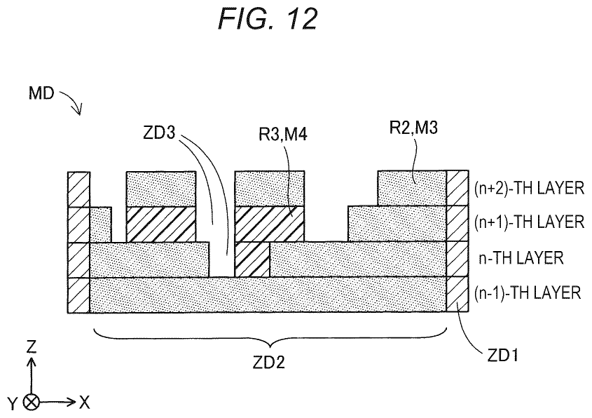

FIG. 12 shows a part of the three-dimensionally shaped object MD shaped in accordance with the method for manufacturing a three-dimensionally shaped object according to the third embodiment. FIG. 12 is a cross-sectional side view of the three-dimensionally shaped object MD. The data generating section 412 generates the third shaping data as described above for all the layers ML. Accordingly, out of the gap regions ZD3 in the layers ML below the (n+2)-th layer, the third discharge path R3 is present in the regions that overlap with the second discharge path R2 in the (n+2)-th layer in the vertical direction. The third discharge path R3 in each of the layers ML is present in the regions that overlap with the second discharge path R2 or the third discharge path R3 in the layer ML immediately below the layer ML in question in the vertical direction. In other words, the data generating section 412 generates the third shaping data on the (n+1)-th layer in such a way that the support material M4 is discharged to the regions that overlap in the vertical direction with the second discharge path R2 or the third discharge path R3 in the n-th layer out of the regions where the second discharge path R2 in the (n+2)-th layer and the gap regions ZD3 in the (n+1)-th layer overlap with each other in the vertical direction.

According to the third embodiment described above, the data generating section 412 generates the third shaping data on the (n+1)-th layer in such a way that the support material M4 is discharged to the regions that overlap in the vertical direction with the second discharge path R2 or the third discharge path R3 in the n-th layer out of the regions where the second discharge path R2 in the (n+2)-th layer and the gap regions ZD3 in the (n+1)-th layer overlap with each other in the vertical direction. Therefore, in the shaping of the three-dimensionally shaped object MD, the support material M4 can be disposed at positions where the support material M4 supports the shaping material M3 in the layer ML immediately above. The thus disposed support material M4 can suppress shift of the positions of the shaping material M3 discharged to regions above the support structure MD2 due to gravity before the shaping material M3 cures, and even a low-filling-rate shaped object MD1 can be shaped with high accuracy.

In the present embodiment, the data generating section 412 generates the third shaping data for each of the layers sequentially through the layers ML from top to bottom. The third shaping data on the (n+1)-th layer can therefore be generated by using information on the third discharge path R3 in the (n+2)-th layer.

### D. Fourth Embodiment

In a fourth embodiment, the processes in steps S60 and S70 of the method for manufacturing a three-dimensionally shaped object differ from those in the first embodiment. The processes other than those in steps S60 and S70 and the configuration of the three-dimensionally shaping system 10 are the same as those in the first embodiment.

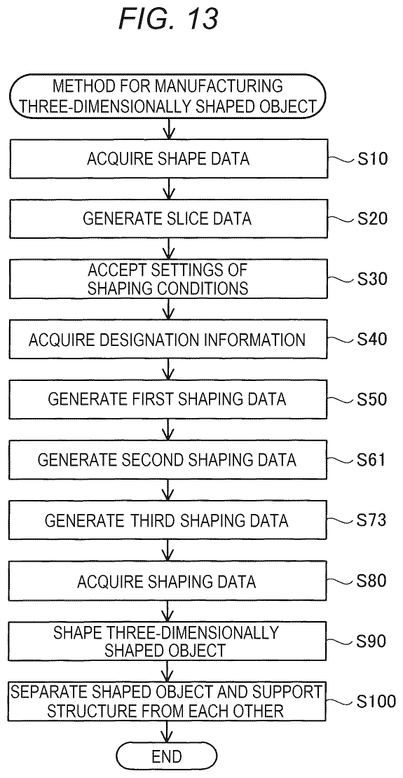

FIG. 13 shows steps of the method for manufacturing a three-dimensionally shaped object according to the fourth embodiment. In FIG. 13, steps in which the same processes as those in FIG. 7 are carried out have the same reference characters as those in FIG. 7, and will not be described.

In step S61, the data generating section 412 generates the second shaping data by setting a part of the path of an infilling path pattern P1 indicating a movement path along which the discharger 60, which fills the inner region ZD2 with the shaping or support material, moves, as the second discharge path R2. FIG. 14 shows an example of the infilling path pattern P1. The infilling path pattern P1 is, when the nozzle 61 is moved along the infilling path pattern P1 to discharge the plasticized material, the movement path along which the discharged plasticized material fills the entire inner region ZD2.

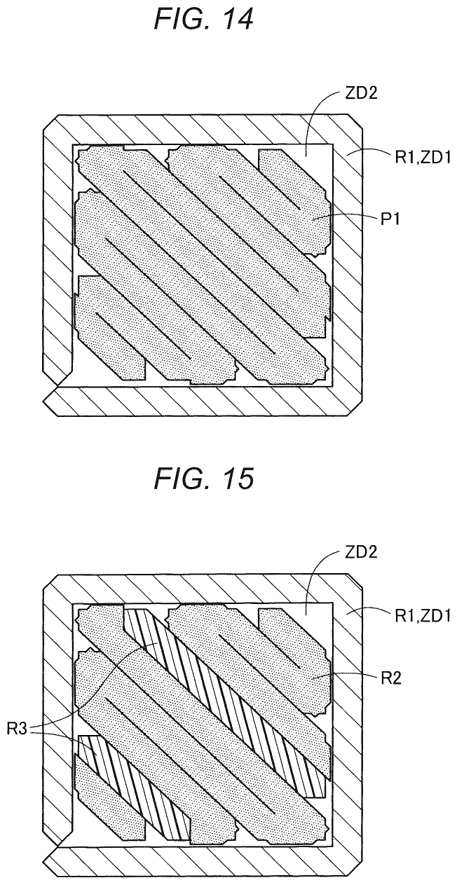

FIG. 15 illustrates the path along which the plasticized material is discharged in one layer ML in the fourth embodiment. FIG. 15 shows the state in which one layer ML is viewed from above. The data generating section 412 determines a part of the infilling path pattern P1 shown in FIG. 14 as the second discharge path R2, as shown in FIG. 15. The data generating section 412 determines the second discharge path R2 in such a way that the filling rate of the shaping material M3 in each of the layers ML is equal to the designation information. The data generating section 412 determines the second discharge path R2 in such a way that the center of gravity of the shaped object MD1 after the support structure MD2 is separated is located in the vicinity of the center of the shaped object MD1.

In step S73 in FIG. 13, the data generating section 412 generates the third shaping data by setting the path other than the second discharge path R2 out of the infilling path pattern P1 as the third discharge path R3. The data generating section 412 determines the path other than the path determined as the second discharge path R2 in step S61 out of the infilling path pattern P1 shown in FIG. 14 as the third discharge path R3, as shown in FIG. 15.

According to the fourth embodiment described above, the data generating section 412 generates the second shaping data by setting a part of the path of the infilling path pattern P1 as the second discharge path R2, and generates the third shaping data by setting the path of the infilling path pattern P1 other than the second discharge path as the third discharge path R3. Therefore, in the shaping of the three-dimensionally shaped object MD, the support material M4 is discharged to the regions of the inner region ZD2 where the shaping material M3 is not discharged. The thus discharged support material M4 can suppress shift of the positions of the shaping material M3 discharged to regions above the support structure MD2 due to gravity before the shaping material M3 cures. Even a low-filling-rate shaped object MD1 can therefore be shaped with high accuracy.

### E. Fifth Embodiment

In a fifth embodiment, the process in step S70 of the method for manufacturing a three-dimensionally shaped object differs from that in the first embodiment. The processes other than that in step S70 and the configuration of the three-dimensionally shaping system 10 are the same as those in the first embodiment.

In the fifth embodiment, in step S70, the data generating section 412 generates the third shaping data in such a way that an infilling path pattern P3 contained in the third shaping data differs from an infilling path pattern P2 contained in the second shaping data. Specifically, the data generating section 412 determines the third discharge path R3 in such a way that the infilling path pattern P3 for the third discharge path R3 differs from the infilling path pattern P2 for the second discharge path R2.

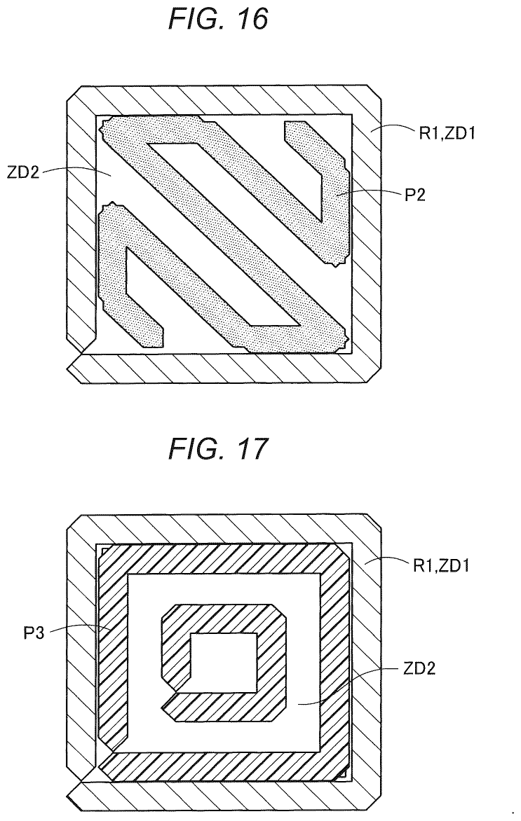

FIGS. 16 and 17 illustrate the infilling path patterns. FIG. 16 shows the infilling path pattern P2 for the second discharge path R2, and FIG. 17 shows the infilling path pattern P3 for the third discharge path R3. The infilling path pattern P2 is a pattern that obliquely crosses the inner region ZD2, and the infilling path pattern P3 is a pattern that draws rectangles in the inner region ZD2.

FIG. 18 illustrates the path along which the plasticized material is discharged in one layer ML in the fifth embodiment. FIG. 18 shows the state in which one layer ML is viewed from above. Since the infilling path pattern P2 and the infilling path pattern P3 differ from each other, the third discharge path R3 is at least partially located in each gap between segments of the second discharge path R2 in one layer ML, as shown in FIG. 18. In the fifth embodiment, a single layer ML has a portion where the second discharge path R2 and the third discharge path R3 overlap with each other, as shown in FIG. 18. Accordingly, while the support material M4 is discharged from the second nozzle 61b, the shaping material M3 having already discharged is likely to adhere to the second nozzle 61b. It is therefore preferable to increase the frequency of cleaning the second nozzle 61b.

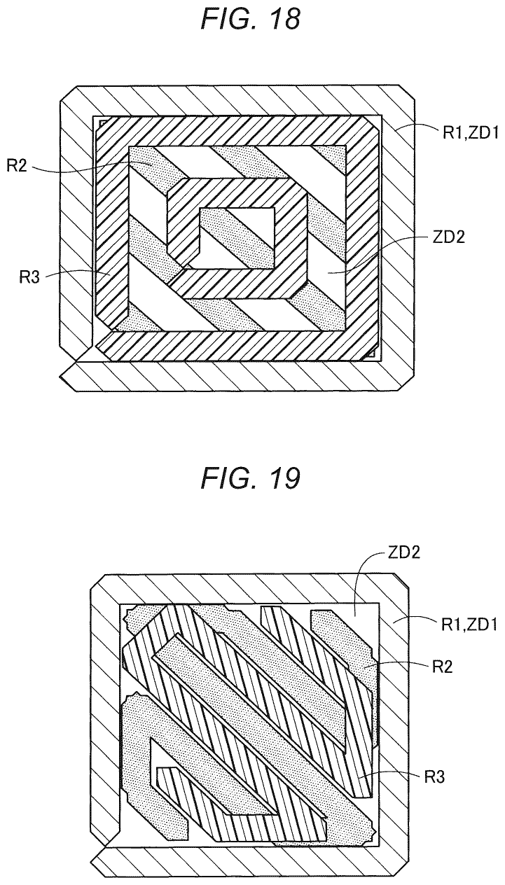

Note that the data generating section 412 may determine the third discharge path R3 in such a way that the infilling path pattern P3 for the third discharge path R3 is the same as the infilling path pattern P2 for the second discharge path R2. In this case, the data generating section 412 determines the third discharge path R3 in such a way that the area where the second discharge path R2 and the third discharge path R3 overlap with each other in a single layer ML decreases, as shown in FIG. 19.

According to the fifth embodiment described above, the data generating section 412 generates the third shaping data in such a way that the infilling path pattern P3 contained in the third shaping data differs from the infilling path pattern P2 contained in the second shaping data. Since the infilling path pattern P2 and the infilling path pattern P3 differ from each other, the third discharge path R3 is at least partially located in each gap between segments of the second discharge path R2 in one layer ML. Even a low-filling-rate shaped object MD1 can therefore be shaped with high accuracy, as in the first embodiment.

### F. Other Embodiments

(F-1) In the embodiments described above, in step S60 in FIG. 7, the data generating section 412 generates the second shaping data in such a way that the holes that communicate with the inner region ZD2 are formed in the three-dimensionally shaped object MD when the shaping of the three-dimensionally shaped object MD is completed. Instead, in step S50 in FIG. 7, the data generating section 412 may generate the first shaping data in such a way that the holes that communicate with the inner region ZD2 are formed in the three-dimensionally shaped object MD when the shaping of the three-dimensionally shaped object MD is completed.

(F-2) In the embodiments described above, the raw material M1 of the shaping material is made of a material insoluble in water or a solvent, and the raw material M2 of the support material is made of a material soluble in water or a solvent. Instead, the raw material M1 of the shaping material may be made of a material containing metal powder and a binder, and the raw material M2 of the support material may be made of a material containing resin. The metal powder is made of a single metal such as magnesium (Mg), iron (Fe), cobalt (Co), chromium (Cr), aluminum (Al), titanium (Ti), copper (Cu), or nickel (Ni), powder containing two or more of the metals described above, or an alloy containing two or more of the metals described above. Examples of the alloy described above include a Maraging steel, a cobalt-chromium-molybdenum alloy, a titanium alloy, a nickel alloy, an aluminum alloy, a cobalt alloy, and a cobalt-chromium alloy. The binder contains resin and wax. The resin is acrylic resin, epoxy resin, silicone resin, cellulose-based resin, or any other synthetic resin, or thermoplastic resin such as polylactic acid (PLA), polyamide (PA), polyphenylene sulfide (PPS), or polyetheretherketone (PEEK). According to the aspect described above, the support structure MD2 can be separated from the shaped object MD1 by performing the treatment of degreasing the three-dimensionally shaped object MD having gone through the shaping.

(F-3) In the embodiments described above, the data generating section 412 generates the first shaping data on all the layers ML in step S50 in FIG. 7, generates the second shaping data on all the layers ML in step S60, and generates the third shaping data on all the layers ML in step S70. Instead, the data generating section 412 may generate the first shaping data, the second shaping data, and the third shaping data on the layers one at a time. In this case, the data generating section 412 preferably generates the shaping data for each of the layers sequentially through the layers ML from bottom to top.

(F-4) In the third embodiment, the data generating section 412 generates the third shaping data on a layer basis sequentially through the layers ML from top to bottom. Instead, the data generating section 412 may generate the third shaping data on a layer basis sequentially through the layers ML from bottom to top.

(F-5) In the embodiments described above, the three-dimensionally shaping apparatus 100 includes the two dischargers 60a and 60b. Instead, the three-dimensionally shaping apparatus 100 may include one discharger 60 or may include three or more dischargers 60.

(F-6) The aforementioned embodiments have been described with reference to the material extrusion method in which plasticized material is stacked in the form of a layer, and the present disclosure is applicable to various methods such as an inkjet method, a direct metal deposition (DMD) method, and a binder jet method.

### G. Other Aspects

The present disclosure is not limited to the embodiments described above, and can be implemented in various aspects to the extent that the various aspects do not depart from the intent of the present disclosure. For example, the present disclosure can also be implemented in the following aspects. To solve some or all of the problems described in the present disclosure, or to achieve some or all of the effects of the present disclosure, technical features of the embodiments described above that correspond to the technical features in each of the following aspects can be replaced or combined as appropriate. The technical features can be deleted as appropriate unless described as essential technical features in the present specification.

(1) According to an aspect of the present disclosure, a method of manufacturing a three-dimensionally shaped object is provided. The method for manufacturing a three-dimensionally shaped object is a method for manufacturing a three-dimensionally shaped object including a shaped object and a support structure that supports the shaped object by discharging a shaping material and a support material from a discharger toward a stage to stack layers on each other, the method including: a first step of acquiring designation information that designates a filling rate of the shaped object; a second step of generating first shaping data containing information on a first discharge quantity that is a quantity of the shaping material discharged per unit time by the discharger and information on a first discharge path that is a path along which the shaping material is discharged, and instructing formation of the shaped object in a contour region that constitutes a contour of the shaped object, a third step of generating second shaping data based on the designation information, the second shaping data containing information on a second discharge quantity that is a quantity of the shaping material discharged per unit time by the discharger and information on a second discharge path that is a path along which the shaping material is discharged, and instructing formation of the shaped object in an inner region inside the contour region; a fourth step of generating third shaping data containing information on a third discharge quantity that is a quantity of t the support material discharged per unit time by the discharger and information on a third discharge path that is a path along which the support material is discharged, and instructing formation of the support structure in the inner region; a fifth step of shaping the three-dimensionally shaped object in accordance with the first shaping data, the second shaping data, and the third shaping data; and a sixth step of separating the support structure from the shaped object, and the fourth step includes generating, in one of the layers, the third shaping data in such a way that the third discharge path is at least partially located in a gap between segments of the second discharge path.

The aspect described above, in which the support structure is formed in the gaps present inside the shaped object when the three-dimensionally shaped object is shaped, can suppress shift of the position of the shaping material discharged to a region above the support structure due to gravity before the shaping material cures. Even a low-filling-rate shaped object can therefore be shaped with high accuracy.

(2) In the aspect described above, the fourth step includes identifying based on the second shaping data a gap region that is a region where the shaping material is not discharged in the inner region, and generating the third shaping data in such a way that the support material is discharged to the gap region.

The aspect described above can suppress the discharge of the support material to the region where the shaping material has already been discharged when the three-dimensionally shaped object is shaped.

(3) In the aspect described above, in the fourth step, a lowermost layer of the layers is called a first layer, and the third shaping data on an (n+1)-th layer (n is natural number) is so generated that the support material is discharged to a region that overlaps in a vertical direction with the second discharge path or the third discharge path in an n-th layer out of a region where the second discharge path in an (n+2)-th layer and the gap region in the (n+1)-th layer overlap with each other in the vertical direction.

According to the aspect described above, the support material can be disposed at a position where the support material supports the shaping material in the layer immediately above the support material when the three-dimensionally shaped object is shaped.

(4) In the aspect described above, in the fourth step, the third shaping data is generated for each of the layers sequentially therethrough from above.

According to the aspect described above, the third shaping data on the (n+1)-th layer can be generated by using the information on the third discharge path in the (n+2)-th layer.

(5) In the aspect described above, the second shaping data is generated by setting, as the second discharge path, a part of a path of an infilling path pattern indicating a movement path along which the discharger, which fills the inner region with the shaping or support material, moves, and the third shaping data is generated by setting, as the third discharge path, a path other than the second discharge path of the infilling path pattern.

According to the aspect described above, the support material is discharged to a region of the inner region where the shaping material is not discharged when the three-dimensionally shaped object is shaped. The thus discharged support material can suppress shift of the position of the shaping material discharged to a region above the support structure due to gravity before the shaping material cures.

(6) In the aspect described above, in the third step, the second shaping data is so generated that the second discharge path in the inner region and the first discharge path in the contour region are at least partially in contact with each other.

The aspect described above can suppress, when the support structure is separated from the shaped object, separation of the shaped object in the contour region from the shaped object in the inner region.

(7) In the aspect described above, in the second step, the first shaping data is so generated that a hole that communicates with the inner region is formed in the three-dimensionally shaped object, or in the third step, the second shaping data is so generated that a hole that communicates with the inner region is formed in the three-dimensionally shaped object.

According to the aspect described above, when the three-dimensionally shaped object is immersed in a liquid that dissolves only the support structure, the liquid flows into the interior of the three-dimensionally shaped object, so that the support structure can be readily separated from the shaped object.

What is claimed is:

1. A method for manufacturing a three-dimensionally shaped object including a shaped object and a support structure that supports the shaped object by discharging a shaping material and a support material from a discharger toward a stage to stack layers on each other, the method comprising:
a first step of acquiring designation information that designates a filling rate of the shaped object;
a second step of generating first shaping data containing information on a first discharge quantity that is a quantity of the shaping material discharged per unit time by the discharger and information on a first discharge path that is a path along which the shaping material is discharged, and instructing formation of the shaped object in a contour region that constitutes a contour of the shaped object,
a third step of generating second shaping data based on the designation information, the second shaping data containing information on a second discharge quantity that is a quantity of the shaping material discharged per unit time by the discharger and information on a second discharge path that is a path along which the shaping material is discharged, and instructing formation of the shaped object in an inner region inside the contour region;
a fourth step of generating third shaping data containing information on a third discharge quantity that is a quantity of the support material discharged per unit time by the discharger and information on a third discharge path that is a path along which the support material is discharged, and instructing formation of the support structure in the inner region;
a fifth step of shaping the three-dimensionally shaped object in accordance with the first shaping data, the second shaping data, and the third shaping data; and
a sixth step of separating the support structure from the shaped object,
wherein the fourth step includes generating, in one of the layers, the third shaping data in such a way that the third discharge path is at least partially located in a gap between segments of the second discharge path.

2. The method for manufacturing a three-dimensionally shaped object according to claim 1, wherein
the fourth step includes
identifying based on the second shaping data a gap region that is a region where the shaping material is not discharged in the inner region, and
generating the third shaping data in such a way that the support material is discharged to the gap region.

3. The method for manufacturing a three-dimensionally shaped object according to claim 2, wherein
in the fourth step, a lowermost layer of the layers is called a first layer, and the third shaping data on an (n+1)-th layer (n is natural number) is so generated that the support material is discharged to a region that overlaps in a vertical direction with the second discharge path or the third discharge path in an n-th layer out of a region where the second discharge path in an (n+2)-th layer and the gap region in the (n+1)-th layer overlap with each other in the vertical direction.

4. The method for manufacturing a three-dimensionally shaped object according to claim 3, wherein
in the fourth step, the third shaping data is generated for each of the layers sequentially therethrough from above.

5. The method for manufacturing a three-dimensionally shaped object according to claim 1, wherein
the second shaping data is generated by setting, as the second discharge path, a part of a path of an infilling path pattern indicating a movement path along which the discharger, which fills the inner region with the shaping or support material, moves, and the third shaping data is generated by setting, as the third discharge path, a path other than the second discharge path of the infilling path pattern.

6. The method for manufacturing a three-dimensionally shaped object according to claim 1, wherein
in the third step, the second shaping data is so generated that the second discharge path in the inner region and the first discharge path in the contour region are at least partially in contact with each other.

7. The method for manufacturing a three-dimensionally shaped object according to claim 1, wherein
in the second step, the first shaping data is so generated that a hole that communicates with the inner region is formed in the three-dimensionally shaped object, or in the third step, the second shaping data is so generated that a hole that communicates with the inner region is formed in the three-dimensionally shaped object.
